(19) United States
(12) Patent Application Publication
(10) Pub. No.: US 2012/0065440 A1
(43) Pub. Date: Mar. 15, 2012

(54) APPARATUS FOR CONDUCTING THERMOLYSIS OF PLASTIC WASTE AND METHOD OF THERMOLYSIS IN CONTINUOUS MANNER

(75) Inventors: Daria Fraczak, Jaworzno (PL); Bartlomiej Karbowy, Warszawa (PL); Bartlomiej Samardakiewicz, Pruszkow (PL)

(73) Assignee: CLARITER POLAND SP. ZO.O., Warszawa (PL)

(21) Appl. No.: 13/256,254

(22) PCT Filed: Jun. 30, 2009
(86) PCT No.: PCT/IB2009/052830

§ 371 Date: Nov. 28, 2011

(30) Foreign Application Priority Data
Mar. 14, 2009 (PL) P 387499

(51) Int. Cl. C10G 9/00; B01J 19/00

(52) U.S. Cl. 585/240; 422/184.1

(57) ABSTRACT

The subject of the invention is apparatus and method for thermolysis of waste plastics where reaction residue and carbonization products are removed continuously. Apparatus according to the invention characterized in that after the plastic feeding system (1) the extruder (2) and pyrolysis reactor (3) which is equipped in dual propeller (7) and is connected to external circulation loop (4) with flux heating (5), circulation pump (6) and three-way valve (8) are situated. Method according to the invention is characterized in that plastic waste are continuously fed to the reactor where at 350-450° C. at mixers' 30-1500 rpm the thermolysis is carried then molten plastic in volume 4-10 m³/h is pumped to flux heater with heating power 60-120 KW from where with regulated operating temperature reaction mixture of vapors and liquids is fed back to reactor but products vapors are removed continuously from reactor and condensed in another part of system and reaction by-products are returned to main thermolysis reactor and thermolysis leftovers are received continuously through heat exchanger by three-way valve situated before flux heater to residue tank.

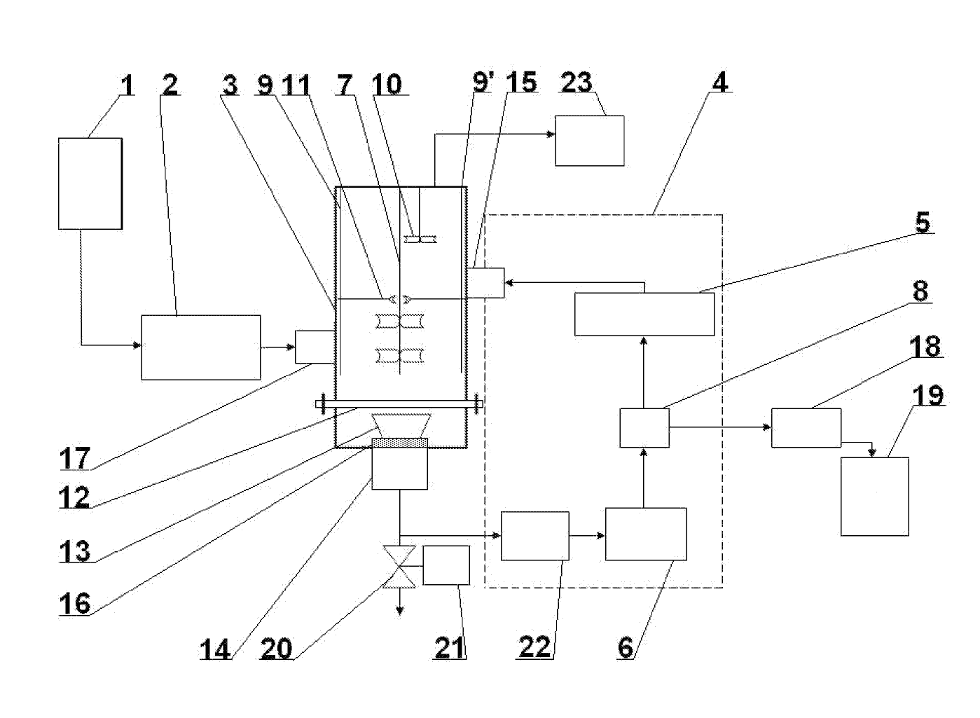

This invention provides an apparatus for conducting thermolysis of the plastic waste and a method of thermolysis with continuous waste plastics feeding and continuous removing carbonization products and reaction leftovers.

U.S. Pat. No. 4,851,601 description, applied for protection on 19 Jan. 1988, defines method of getting hydrocarbon oils from waste plastics which bases on thermal cracking in liquid phase and through catalytic conversion of vapors of cracking products with catalyst presence.

From Japanese Patent description, applied on 19 Aug. 1996, published as a EP0763412 there is known waste plastics pyrolisis reactor which involves reactor with waste plastics inlet locates at one end and liquefied plastic outlet and hydrogen chloride outlet at next end, waste heater situated between plastic inlet and hydrogen chloride outlet. Reactor has a screw funnel heater for conducting plastics in reactor from charge to outlet.

From U.S. Pat. No. 6,066,263 description, applied for protection on 12 Mar. 1998 there is known system for hydrothermal reaction conversion waste plastics into oil. Plant has a tank for keeping mixture of water and plastics, high-pressure pump connected through flow channel and shift valve with tank. Shift valve is connected with water passing channel. Reactor has bowed pipes connected with injection pump. Bowed pipes equipped in heating agents are connected through pressure reduction valve with effluent tank. The velocity of flow of reaction mixture passed to reactor may be controlled by pressure reduction valve. Thermal degradation of the mixture is reached in the reactor device under pressure and temperature conditions equal to, or above, a value by which a supercritical condition of water is achieved, and under the turbulent flow conditions generated partly by the curved piping.

U.S. Pat. No. 6,534,689 description, applied on 24 Aug. 2001, defines method of pyrolysis of the waste plastics led to fuel production. To separate solid particles from liquids the cyclone using high vehicle velocity and high inert gas temperature as heat transfer carrier. Invention utilizes inert gas and hydrocarbon vapors as heating medium.

From patent description No WO 2005/065006, applied with priority on 23 Dec. 2003, it is known a reactor for enrichment of recoverable oil from waste plastics. The invention is a reactor with FIR heater therein that coverts waste plastics into oil. The FIR heater consists of electrical resistance space, far infrared radiator, insulator, protective shell, tight set and other parts. The far infrared ray radiator can be rod-shaped, band-shaped and be made into other shapes, and on the outside is encased by metal pipe, and painted with the far infrared radiator. So the infrared ray can directly heat the plastics thereby turning the waste plastics into oil. This technique of splitting oil dregs and emulsification will scatter the oil dregs into atoms below 100 μm, and combine them in the emulsified oil equitably, and get 30-60 C liquid oil in the emulsification container. Hot oil will be directly changed into burnable liquid oil and it can be stored safely at normal temperatures.

From U.S. Patent Application Publication No U.S.2005/0075521, applied for protection on 20 Jan. 2003, it is known a method and plant for conversion plastics into oil with presence of inert gas. The plastic raw material is dissolved in a dissolution section to form an expanded plastic and sent to an inclined first-stage decomposition column and a second-stage decomposition column. The second-stage decomposition column is adjacent to the first-stage decomposition column. Both columns have fixed temperature distributions. The plastic is depolymerized and decomposed into a light secondarily decomposed gas. The extracted secondarily decomposed gas is cooled into oil in condensers and collected in oil storage tanks.

From polish Patent No P 380619 description, applied for protection on 16 Sep. 2006, it is known the method and apparatus for catalytic depolymerization of polyolefinic waste plastics characterized by two reactors in which depolymerization takes place, one tank reactor and second flow reactor operating in cooperation. Shredded plastic waste are first heated, melted and pumped under the reaction medium surface. Later plastic molten mass is dispersed in the reaction medium. Depolymerization process occurs in presence of the catalyst. From reactor bottom reacting mixture is pumped to the flow reactor in which it is heat up to 400° C. Reaction occurs under normal and negative pressure. Pressure in the reactor depends on the planned outcome product properties. Inside flow reactor depolymerization takes place. Gas and liquid mixture comes in to tank reactor where it is split into gas and liquid fraction. Liquid phase is heated up and melts incoming plastic feedstock. In the bottom reactor area in 360° C. the initial reaction takes place.

In upper section in around 400° C. the split in to gas and liquids takes place. Hydrocarbon vapors produced comes through the active chemically neutralizing filter and condensed. Process is continuous.

From Patent Application P-383709 description, applied for protection on 7 Nov. 2007, it is known the apparatus and method for depolymerization of waste plastics, especially polyolefins, with removing reaction leftovers and residues. Apparatus consisted of feeding conveyor, pyrolysis reactor and discharging section is characterized by gas engaging stabilizer equipped with mixer and working in close loop at least one external pyrolysis reactor with screw or ribbon mixer and pipe that closes the loop. Depolymerization process is carried out with inert gas presence and characterized by reactor enforced dual flow in which one of mixing directions is used as well to discharge the reaction residue.

From patent application No P-386410, applied for protection on 31 Oct. 2008, it is known apparatus for thermolysis of waste plastics, especially polyolefins, and method of thermolysis with continuous feeding and continuous discharging carbonizable substances and reaction leftovers. Apparatus includes plastic feeding system, pyrolysis reactor, discharge system according to the invention is characterized in that after the plastic feeding system are situated the extruder and pyrolysis reactor which height is at least 1.5 time bigger than its diameter. Pyrolysis reactor is equipped with dual high speed propeller. Method for thermolysis of plastic waste especially polyolefins with presence of inert gas according to the claim is characterized that plastic waste are continuously fed to the extruder where are plasticized from 180° C. up to the temperature of the reactor later, and are fed to the pyrolysis reactor where at 350-450° C. at agitator's 30-1500 rpm the thermolysis is carried out with continuous two step fractional condensation where light product boiling below 180° C. goes to storage tank with cold jacket and heavy product boiling above 180° C. is conducted to hot jacket tank.

Principal aim of the invention is method of thermolysis of waste plastics, especially polyolefins, carried out continuously with continuous removing products and reaction residue with simultaneous minimizing carbonizable products formation and collection and apparatus therefore.

Apparatus for conducting waste plastic thermolysis consisting feeding system, reactor for thermolysis which high is at least 1.5 time bigger than its diameter, external circulation loop and products collecting system according to the invention is characterized in that after the feeding system there is an extruder followed by main thermolysis reactor, appointed with dual agitator and connected with external circulation loop involving flux heater, circulation pump and three-way valve.

Favorably thermolysis reactor has at least two vertical internal baffles.

Favorably thermolysis reactor's high is two times bigger than its diameter.

Favorably thermolysis reactor is equipped in independent accessory agitator.

Favorably agitator is high speed mixer with different propeller blade angles.

Favorably agitator is a dual propeller agitator.

Favorably dual propeller agitator is calked by inert gas cooled by liquid.

Favorably agitators shaft is equipped with additional stabilizing bars.

Favorably reactor has an inspection flange in its bottom part.

Favorably in the bottom of the reactor there is a internal anti-whirl device.

Favorably in the bottom of the reactor there is a outlet piece of reaction mixture and after flux heater, in the upper part of reactor wall there is a inlet piece of reaction mixture.

Favorably over outlet piece there is a sieve or filter.

Favorably after extruder squared to reactor wall is inlet piece of plasticized feedstock from extruder and inlet piece of feedstock from circulation loop is tangential to reactor wall.

Favorably inlet piece of plasticized feedstock from extruder into reactor is situated under inlet piece of reaction mixture from circulation loop.

Favorably thermolysis residue collecting system comprises three-way valve in circulation loop, residue cooling system and residue tank.

Favorably residue tank is cooled by current liquid.

Favorably reactor trigger system is equipped in circulation pump, bottom emergency trigger valve and three-way valve.

Favorably bottom trigger emergency valve is equipped in drain mechanism.

Favorably drain mechanism is sealed hand drain bar.

Favorably circulation pump is following a filter.

Favorably circulation pump is a vortex pump.

Favorably circulation pump is heated externally by oil heating jacked.

Favorably circulation pump is calked by inert gas cooled by liquid.

Favorably flux heater is heated electrically.

Plastic waste thermolysis method in inert atmosphere in which waste are fed continuously to extruder and plasticized in temperature from 180° C. up to temperature in reactor according to invention is characterized in that plastics are fed into thermolysis reactor where thermolysis is carried out in temperature from 350° C. to 450° C. with agitator 30-1500 rpm then plasticized waste are pumped with velocity of flow from 4 to 10 m³/h to the flux heater with heating power about 60 to 120 KW, from where mixture of liquid and vapors with regulated temperature of system is injected back to reactor and vapors of reaction products are off taken continuously from reactor and condensed in following part of system, thermolysis by-products are returned to main thermolysis reactor and reaction leftovers are received continuously through heat exchanger by three-way valve situated before flux heater to residue tank.

Favorably thermolysis process is carried out in temperature range 390 to 430 C.

Favorably thermolysis process is carried out with 200 to 700 rpm of agitator.

Favorably wastes are plasticized in extruder in temperature range 250 to 370° C.

Favorably plasticized plastic is pumped with velocity of flow 6 to 9 m³/h.

Favorably heating power of flux heater is 70 to 90 KW.

Main advantage of the invention is designing of small size process equipment for continuous thermolysis carrying out and giving high repeatable products with lower temperature regime without catalysts with remover heating center to external loop of reactor.

Thermolysis process is very stable due to small temperature difference between temperature of plasticized feedstock and thermolysis temperature. It causes considerably decrease of energy consumption for depolymerization and lowering of feedstock residence time in the reactor affecting much lower tendency to producing coke inside reactor and whole system. External circulation loop outside reactor connected with reactor by pipes and two spouts—inlet and outlet—allows forced move of reaction mixture in system thermolysis reactor—circulation loop and lowering carbonization. Additionally reducing volume of coke is caused by using circulation pump which causes reducing contact time of reaction mixture and hot walls of heating system.

Using electrical flux heater moved heating place for process from thermolysis reactor and improved heating efficiency and reduced heat loss. Implementing the reactor with elongated shape and with vertical baffles enables proper mixing. More over implementing high speed dual mixer causes more efficient mixing and equal temperature distribution inside reactor. Inspection flange enables stripping of reactor bottom.

Important advantage of the invention is three-way valve working in temperature of reactor so flux pumped from pump is divided on stream run to heater and stream of residue maintenance-free removed. This method gives very wide hydrocarbon fraction.

The object of the invention is reconstructed in example on the fig—scheme of the system for thermolysis of polyolefins.

Example of implementation caused below do not limit possibilities of use of the invention.

System Implementation

Apparatus for conducting thermolysis of plastic waste according to the invention is characterized by granulated or leaf-shaped feedstock feeding system 1 to the extruder 2. Plasticized in the extruder 2 granulate, heated up to 300-330° C., is fed through inlet piece 17 to reactor 3 in which thermolysis process takes place. Reactors 3 high is two times bigger than its diameter. Reactor 3 is equipped in dual high-speed propeller 7 with different propeller blade angle. Dual high-speed propeller 7 is calked by inert gas cooled by liquid. Reactor 3 is equipped in two internal vertical baffles on the walls 9 and 9′. Agitators shaft is equipped with additional stabilizing bars 11. Moreover reactor 3 is equipped in independent accessory agitator 10 which eliminates foam forming. In the bottom of reactor 3 inspection flange 12 and anti-whirl device 13 are set up. Thermolysis process of molten plastic is carried out in temperature from 390 to 460° C. and with 200 to 700 rpm of agitator. In the bottom of the thermolysis reactor 3 is an reaction mixture outlet piece 14 and mechanical filter 16. Plasticized polymer is fed through outlet piece 14 and circulation pump 6 to external circulation loop 4 with velocity of flow 6 to 9 m³/h. Before circulation pump 6 is set up a filter 22. In circulation loop 4 reaction mixture flow through three-way valve 8 and through electrical flux heater 5 which controls process temperature. Heating power of flux heater is 70 to 90 KW. The mixture of vapors and liquid is continuously conducted through inlet piece 15 back to thermolysis reactor 3. Vapors from the process are collected in other part of the system 23 and condensed into liquid product. Thermolysis residue are collected continuously also by external circulation loop 4 in discharge system through three-way valve 8 dividing pumped stream of reaction mixture on stream conducted to residue cooling system 18 and leftovers tank 19 and main product stream conducted through flux heater 5 and inlet piece 15 situated tangential to reactor wall. Under the bottom of the reactor 3 is set up bottom emergency trigger valve 20 which is equipped in drain mechanism 21. Drain mechanism 21 is manual or pneumatic punch. Thermolysis process is carried out in an inert gas atmosphere. Thermolysis product is a very wide hydrocarbon fraction for further rework.

1-30. (canceled)

31. Apparatus for conducting waste plastic thermolysis consisting a feeding system, a reactor for thermolysis which high is at least 1.5 times bigger than its diameter, an external circulation loop and products collecting system, wherein after the feeding system (1) there is an extruder (2) followed by main thermolysis reactor (3), appointed with dual agitator (7) and connected with external circulation loop (4) involving flux heater (5), circulation pump (6) and three-way valve (8).

32. The apparatus according to claim 31 wherein the thermolysis reactor (3) having at least one of:
at least two vertical internal baffles (9) and (and 9′); a height two times bigger than its diameter; being equipped in independent accessory agitator (10); and
a trigger system equipped in a circulation pump (6), bottom emergency trigger valve (20) and three-way valve (8).

33. The apparatus according to claims 31 wherein the agitator (7) being at least one of:
a high speed mixer with different propeller blade angles;
a dual propeller agitator;
calked by inert gas cooled by liquid; and
having a shaft equipped with additional stabilizing bars (11).

34. The apparatus according to claim 31 wherein the reactor (3) having at least one of:
an inspection flange (12) in its bottom part;
an internal anti-whirl device (13)in the bottom; and
an outlet piece (14) of reaction mixture and after flux heater (5), in the upper part of reactor (3) wall there is a inlet piece (15) of reaction mixture.

35. The apparatus according to claim 34 wherein over the outlet piece (14) there is a sieve or filter (16).

36. The apparatus according to claim 31 wherein after extruder (2), squared to reactor (3) wall is inlet piece (17) of plasticized feedstock from extruder (2) and inlet piece (15) of feedstock from circulation loop is tangential to reactor (3) wall.

37. The apparatus according to claim 36 wherein the inlet piece (17) of plasticized feedstock from extruder (2) into reactor is situated under inlet piece (15) of reaction mixture from circulation loop (4).

38. The apparatus according to claim 31 wherein the thermolysis residue collecting system comprises three-way valve (8) in circulation loop (4), residue cooling system (18) and residue tank (19).

39. The apparatus according to claim 38 wherein the residue tank (19) is cooled by current liquid.

40. The apparatus according to claim 32 wherein the bottom emergency trigger valve (20) is equipped in drain mechanism (21) and optionally drain mechanism (21) is a sealed hand drain bar.

41. The apparatus according to claim 31 wherein the circulation pump (6) being one of:
following a filter (22)
being a vortex pump;
being heated externally by oil heating jacked; and
being calked by inert gas cooled by liquid.

42. The apparatus according to claim 31 wherein the flux heater (5) is heated electrically.

43. Plastic waste thermolysis method in inert atmosphere in which waste is fed continuously to an extruder and plasticized in a temperature from 180 degrees centigrade up to a temperature in reactor, wherein plastics are fed into a thermolysis reactor where thermolysis is carried out at a temperature from 350 degrees centigrade to 450 degrees centigrade with agitator 30-1500 rpm then plasticized waste is pumped with a velocity of flow from 4 to 10 m³/h to a flux heater with heating power about 60 to 120 KW, the mixture of liquid and vapors with regulated temperature of system thereafter is injected back to the reactor and vapors of reaction products are removed continuously from the reactor and condensed in the subsequent part of the system, thermolysis by-products are returned to the main thermolysis reactor and reaction leftovers are received continuously through heat exchanger by three-way valve situated before flux heater to residue tank.

44. The method according to claim 43 wherein the thermolysis process being at least one of:
carried out in temperature range 390 to 430 degrees centigrade;
carried out with 200 to 700 rpm of agitator;
plasticizing the wastes in the extruder in a temperature range of 250 to 370 degrees centigrade;
wherein the plasticized plastic is pumped with velocity of flow 6 to 9 m³/h. and wherein the heating power of flux heater is 70 to 90 KVV.
